(19) United States
(12) Patent Application Publication
(10) Pub. No.: US 2013/0116459 A1
(43) Pub. Date: May 9, 2013

(54) METHOD AND APPARATUS FOR ACOUSTICALLY MANIPULATING BIOLOGICAL PARTICLES

(71) Applicant: Los Alamos National Security, LLC, Los Alamos, NM (US)

(72) Inventors: Babetta Louise Marrone, Los Alamos, NM (US); Daniel M. Kalb, Los Alamos, NM (US); James Elmer Coons, Los Alamos, NM (US); Taraka Dale, Los Alamos, NM (US)

(73) Assignee: LOS ALAMOS NATIONAL SECURITY, LLC, Los Alamos, NM (US)

(21) Appl. No.: 13/652,296

(22) Filed: Oct. 15, 2012

Related U.S. Application Data
(60) Provisional application No. 61/546,742, filed on Oct. 13, 2011.

(51) Int. Cl. C11B 1/10; B06B 3/00

(52) U.S. Cl. CPC C11B 1/106; B06B 3/00
USPC 554/175; 422/127; 435/257.1; 435/6.1; 435/29

(57) ABSTRACT

Systems and methods for concentrating biological particles in a liquid suspension use acoustic focusing technology. In some instances, the systems and methods include extracting and separating a target material from the concentrated biological particles in the liquid suspension. Algae cells can be concentrated and lipids isolated from the algae for the production of biofuel.

### CROSS REFERENCE TO RELATED APPLICATIONS

This application claims the benefit of U.S. Provisional Application No. 61/546,742, filed Oct. 13, 2011, which is herein incorporated by reference in its entirety.

### ACKNOWLEDGEMENT OF GOVERNMENT SUPPORT

This invention was made with government support under Contract No. DE-AC52-06NA25396 awarded by the U.S. Department of Energy. The government has certain rights in the invention.

### FIELD

The present disclosure concerns systems and methods for concentrating biological particles in a liquid suspension by applying an acoustic field. The disclosure further concerns methods for isolating lipids from algae by applying an acoustic field.

### BACKGROUND

As worldwide petroleum deposits decrease, there is rising concern over shortages and the costs that are associated with the production of hydrocarbon products. As a result, alternatives to products that are currently processed from petroleum are being investigated. In this effort, biofuel such as biodiesel has been identified as a possible alternative to petroleum-based transportation fuels. In general, a biodiesel is a fuel comprised of mono-alkyl esters of long chain fatty acids derived from plant oils or animal fats. In industrial practice, biodiesel is created when plant oils or animal fats are reacted with an alcohol, such as methanol.

For plant-derived biofuel, solar energy is first transformed into chemical energy through photosynthesis. The chemical energy is then refined into a usable fuel. Currently, the process involved in creating biofuel from plant oils is expensive relative to the process of extracting and refining petroleum. It is possible, however, that the cost of processing a plant-derived biofuel could be reduced by minimizing the costs associated with extracting plant oils. Because algae are known to be one of the most efficient plants for converting solar energy into cell growth, it is of particular interest as a biofuel source. However, current algae processing methods have failed to result in a cost effective algae-derived biofuel. In algal biofuels operations, acoustic focusing would replace a centrifuge for collecting and dewatering (harvesting) algae. One problem is that the algae may be harvested before they are producing maximal lipids. Another problem is that outdoor ponds may contain a significant amount of bacteria that compete for nutrients or otherwise reduce algal growth or lipid production. It is also difficult to rapidly (in real-time) monitor lipid production in algal cultivation ponds. Additionally, it is currently not possible to rapidly monitor bacterial contamination in algal cultivation systems.

### SUMMARY

The present disclosure provides apparatus, systems and methods for concentrating biological particles from a liquid suspension, and optionally extracting and isolating target material from the biological particles, using acoustic energy. The disclosed apparatus, systems and methods can be used, for example, to concentrate algae cells from an algae culture, and extract and separate lipids from the concentrated algae, such as for the production of biofuel.

Apparatus comprise an acoustic transducer configured to produce an acoustic wave in a liquid suspension of biological particles; a liquid distributor situated and configured to provide a substantially uniform flow in the liquid suspension of biological particles, wherein the substantially uniform flow is directed so that at least some of the biological particles accumulate in the acoustic wave at accumulation regions defined by the acoustic wave; and a drain configured to collect a portion of a liquid suspension having an enriched concentration of biological particles associated with the accumulated biological particles. In some embodiments, the apparatus further includes a chamber configured to receive the substantially uniform flow and situated with respect to the acoustic transducer so that the accumulation regions are defined in the chamber. In some embodiments, the apparatus further includes an acoustic signal generator coupled to the acoustic transducer and configured to establish accumulation regions based on an acoustic standing wave, an acoustic traveling wave, or a combination thereof.

In some examples, extraction systems include an acoustic concentrator configured to produce a particle enriched fluid based on an applied acoustic field; an acoustic extractor coupled to receive the biological particle enriched fluid from the acoustic concentrator and extract a target material from the biological particles; and an acoustic separator configured to separate the extracted target material. In some embodiments, the acoustic extractor comprises a piezoelectric chamber having electrodes on an inner surface and an outer surface. The acoustic separator typically comprises an acoustic transducer configured to produce an acoustic wave within a chamber and establish an accumulation region. A liquid distributor is situated within the chamber and configured to provide a substantially uniform flow of a liquid suspension containing the biological particles.

In still further examples, methods of concentrating biological particles from a liquid suspension include applying an acoustic field to the liquid suspension to concentrate the biological particles; and separating the concentrated biological particles from the liquid suspension. In some examples, the acoustic field includes a standing wave, a pulsed standing wave, a traveling wave, a radial acoustic field or a surface acoustic wave. In some examples, the biological particles are cells, such as algae cells.

According to additional examples, methods of isolating lipids from algae include applying an acoustic field to a liquid suspension of algae to concentrate the algae; applying an acoustic field to the concentrated algae to extract lipids from the algae; and applying an acoustic field to separate the lipids from the algae.

The foregoing and other features of the disclosed technology will become more apparent from the following detailed description, which proceeds with reference to the accompanying figures.

### BRIEF DESCRIPTION OF THE DRAWINGS

FIG. 1A is a picture of a flow-through acoustic harvester showing concentrated algae at the bottom and dilute algae near the top. FIG. 1B shows algae accumulating at the pressure nodes, seen as concentrated vertical lines in the acoustic harvester. FIG. 1C shows a flow-through/batch acoustic extractor. FIG. 1D shows a batch acoustic separator with canola oil droplets accumulating at the pressure anti-nodes and large oil agglomerates at the vessel wall.

FIG. 2A depicts a four-layered resonator system. The layered structure on the left side shows the arrangement and thickness of a 4 layered resonator vessel where a liquid (L) layer contains algae-like particles and a PZT (P) layer is attached to thin electrodes (E) on both sides. The electrodes and PZT layer form an acoustic transducer that is secured to a carrier plate (C) such as a glass plate. The vessel is terminated by a reflector (R), typically a glass plate. FIG. 2B is a plot showing the predicted admittance-frequency spectra for a one (EPE), two (EPEC), and four (EPECLR) layered resonator vessel. Admittance spectra are measured independently using an impedance analyzer and layer properties are determined by comparing measured spectra. Multiple overtone resonance/anti-resonance frequencies are observed as a consequence of the thickness of a layer (e.g., the liquid layer) being large relative to the wavelength of the propagating sound wave.

FIG. 3A is a histogram showing BODIPY fluorescence in three different Nannochloris sp. samples with varying levels of fatty acid methyl esters (FAMEs). Unstained samples show very little fluorescence, while stained samples show a delineation from low to high fluorescence. Inset of fluorescence images shows larger and brighter lipid bodies in algal cells containing high (H) levels of FAMEs. FIG. 3B shows a comparison of lipid quantification methods for a culture of Nannochloris sp. The BODIPY fluorescence correlates well with the FAME values (in μg/cell) acquired by GC-MS. FIG. 3C shows assays used to analyze algal samples, including cell size (forward scatter), cell granularity (side scatter), cell count, DNA content, lipid content and autofluorescence.

FIGS. 4A-4B show typical results indicating optimum operating conditions for a 120 ml concentrator vessel. FIG. 4A shows that for a fixed voltage, the energy consumed by the resonator is frequency dependent and optimum performance was pursued at minimum energy consumption. In FIG. 4B, for a fixed concentration, the concentrator performance is shown over a range of feed rates and power. The optimum flow rates were around 2, 4, and 15 ml/min going from lowest to highest power. Error bars on the high power data indicate +/−one standard deviation of three replicate tests.

FIGS. 5A-5B show typical results aimed at elucidating optimum operating conditions for the 7 ml extractor. FIG. 5A demonstrates that for a fixed voltage, the energy consumed by the resonator is frequency dependent and optimum performance was pursued at minimum energy consumption (i.e., circa 80 kHz). FIG. 5B demonstrates for a fixed concentration, the extractor performance is shown with increasing time. Significant changes occur within the first 5 minutes of powering the extractor and over slightly longer time periods for the lowest power investigated.

FIGS. 6A-6C show the application of the layered resonator model for material property measurement and exploration of system control strategies to optimize energy efficiency of the acoustic harvester. Admittance spectrum calculated by the model overlayed onto the measured spectrum of a 2-layer resonator and a 4-layer resonator are shown in FIG. 6A and FIG. 6B, respectively. FIG. 6C shows the overlay of the minimum phase angle with performance numbers (i.e. indicating energy efficiency) over a broad operating range.

FIG. 7 demonstrates selective harvesting of high-lipid algae. Input algae were from high- and low- lipid cultures. A 50:50 mixture was prepared and placed in a 4 ml cuvette. 1.5-MHz frequency sound waves were applied for 4 minutes. Samples were collected from the top (waste) and bottom (concentrated) of the cuvette and measured by flow cytometry. The samples collected from the bottom of the cuvette had greater light scatter and BODIPY fluorescence, indicating that the ultrasound was preferentially concentrating the larger, high-lipid algae from the mixture.

FIG. 8 is a representative process flow diagram (PFD) based on acoustic harvester and extractor experiments. The energy input for each unit process is provided in units of $US per gallon of lipid. Total costs range from $0.45 to $0.11 per gallon, depending on the assumptions made (Case 1—low efficiency resonator; Case 2—high efficiency resonator; and Case 3—large algae size).

FIG. 9 is a diagram showing a representative acoustic harvesting system. The system consists of a function generator to create a sinusoidal ultrasonic (20-Khz or larger) wave, a power amplifier to increase the AC voltage of the function generator, one PZT to drive the system, one PZT to detect resonance, and an oscilloscope to check waveforms. A flow-through container received an algae mixture that is subjected to the ultrasonic field by the 1.5 Mhz PZT.

FIG. 10 is a diagram of a representative liquid distributor comprising a tube having holes situated along the tube length.

FIG. 11 is a diagram of a representative drain pocket with a slope to enhance flow through of a concentrated liquid suspension of biological particles.

FIG. 12 is a diagram of a representative acoustic concentrator with a plurality of acoustic transducer sections, a liquid distributor extending through a chamber and a spillway situated vertically at the top of the chamber. The acoustic concentrator also includes a drain tube with a drain pocket sloped to enhance flow through of a concentrated liquid suspension of biological particles.

FIG. 13 is a process flow diagram of a representative acoustic harvesting system.

FIG. 14 is a diagram of a representative acoustic harvester system.

FIG. 15 is a diagram of a representative acoustic harvester module.

FIG. 16 is a process flow diagram of a representative acoustic extractor system.

FIG. 17 is a diagram of a representative acoustic extractor system.

FIG. 18 is a diagram of a representative acoustic extractor module.

FIG. 19 is a diagram of a representative acoustic separator module, receiving a feed stream from the extractor system.

### DETAILED DESCRIPTION

### I. Introduction

Algae-based fuels are a source of renewable energy that has high potential for being economically viable and environmentally sound. However, innovative technologies are needed that can enable production of algal biofuels at commercial scale. Harvesting microalgae from cultivation ponds for conversion to fuel is a challenging step to implement efficiently at industrial scale because current methods involving centrifugation or filtration are energy-intensive. In addition, current methods for lipid extraction of algae require drying the algae, and the use of hazardous solvents for oil extraction. Disclosed herein are cost-effective processes for harvesting and lipid extraction of algae using acoustic fields to concentrate the algae, then release and separate lipids from the algal cells. The ultrasonic harvesting process is rapid, leaves no toxic residues, and uses no mechanical parts that can break or foul. The results described herein demonstrate the feasibility of ultrasonic harvesting and extraction with respect to low capital and operating costs, and the effectiveness of the system with multiple types of microalgae. The quality of the lipids and protein co-products after ultrasonic harvesting and extraction is high.

### II. Terms

Unless otherwise noted, technical terms are used according to conventional usage. Definitions of common terms in molecular biology may be found in Benjamin Lewin, Genes V, published by Oxford University Press, 1994 (ISBN 0-19-854287-9); Kendrew et al. (eds.), The Encyclopedia of Molecular Biology, published by Blackwell Science Ltd., 1994 (ISBN 0-632-02182-9); and Robert A. Meyers (ed.), Molecular Biology and Biotechnology: a Comprehensive Desk Reference, published by VCH Publishers, Inc., 1995 (ISBN 1-56081-569-8).

In order to facilitate review of the various embodiments of the disclosure, the following explanations of specific terms are provided:

Accumulation regions: Spatial locations at which particles in a liquid suspension tend to concentrate, aggregate, or agglomerate so as to be retained and are not carried along with a liquid flow. Such regions can be defined by nodes or antinodes of an acoustic field, and accumulated particles separated from a flow by gravitational forces.

Algae: A large and diverse group of prokaryotic and eukaryotic, photosynthetic organisms that grow in aquatic habitats. Algae are typically autotrophic (self-feeding) and can range from unicellular to multicellular. Microalgae are unicellular algae found in freshwater and marine systems. The present disclosure contemplates the use of any species of algae, for example microalgae, from which lipids and/or oils can be extracted, such as for biofuel production. In some embodiments of the present disclosure, the algae species is from the class or genus Nannochloropsis, Chlorella, Tetraselmis, Bacillariophyceae, Chlorophyceae, Cyanophyceae, Xanthophyceae, Chrysophyceae, Crypthecodinium, Schizocytrium, Ulkenia, Dunaliella, Cyclotella, Navicula, Nitzschia, Cyclotella, Phaeodactylum or Thraustochytrid, Botryococcus, Ankistrodesmus, Coelastrum, Scenedesmus, Klebsormidium, Dictyochloropsis, Kirchneriella, Phormidium, Lyngbya, Oocystis, Oscillatoria, Cosmarium, Leptolyngbya, Monoraphidium, Phormidium, Ulothrix, Anabaena, Uronema, Hydrodictyon, Chlorococum, Cladophora or Lemna. Diatoms, Chlorophyta (green algae), Euglenophyta, Dinoflagellata, Chrysophyta, Phaeophyta (brown algae), Rhodophyta (red algae), and Cyanobacteria (blue-green algae) are also encompassed by the present disclosure. The algae can also be genetically altered, transgenic, environmentally adapted or synthetic algae.

Biofuel: A type of fuel whose energy is derived from biological carbon fixation. Algae, particularly species that produce high levels of oils and lipids, are one source of biofuel precursors (e.g., oil or lipid).

Biological particles: In the context of the present disclosure, “biological particles” are any biological material capable of suspension in a liquid (such as water or culture medium). Biological particles include, but are not limited to cells, for example human or non-human animal cells (such as blood cells), plant cells (such as algae cells), yeast cells or prokaryotic (bacterial) cells. Cellular organelles, cell structures and cell debris are also encompassed by the term biological particle. Biological particles attached to non-biological supports such as microspheres are also included.

Enriched: As used herein, an “enriched” concentration of biological particles refers to a liquid suspension in which the biological particles have been concentrated at least 10%, at least 20%, at least 30%, at least 40%, at least 50%, at least 60%, or at least 70% with respect to the initial concentration of the biological particles in the suspension.

Extract: To remove or make accessible. For example, lipids and other cellular materials are extracted from algae cells by disrupting the membranes of the algae, thereby removing the lipids (and other cellular materials) from the algae cells and/or making the lipids accessible for later separation.

Harvest: To collect, concentrate or remove cells or a crop (such as algae). In the context of the present disclosure, a harvester collects and/or prepares biological particles (such as algae) for subsequent concentration, extraction and separation. In some instances, the harvester initiates concentration of the biological particles.

Separate: To isolate, sort or remove from a mixture. For example, following extraction of lipids and other cellular material from algae cells, the lipids are separated from the other cellular materials.

Substantially uniform flow: As used herein, a “substantially uniform flow” in a liquid suspension refers to a liquid suspension with a uniform flow velocity that varies less than 25%, less than 20%, less than 15%, less than 10% or less than 5% over approximately 90%, 75%, 60%, 50%, or 25% of a flow cross-sectional area perpendicular to a flow direction. In typical examples, such a flow is established as a laminar flow in a sheet extended through and into acoustic accumulation regions.

Target material: Any component of a biological particle that is to be extracted from the biological particle. For example, when the biological particle is a cell, possible target materials include, but are not limited to lipids, oils, and proteins.

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

### III. Overview of Several Embodiments

The present disclosure provides apparatus, systems and methods for concentrating biological particles from a liquid suspension, and optionally extracting and isolating target material from the biological particles, using acoustic focusing technology. The disclosed apparatus, systems and methods can be used, for example, to concentrate algae cells from an algae culture, and extract and separate lipids from the concentrated algae, such as for the production of biofuel.

A. Representative Apparatus for Concentrating Biological Particles

Provided herein is an apparatus that can be used to concentrate biological particles from a liquid suspension. The apparatus includes an acoustic transducer configured to produce an acoustic wave in a liquid suspension of biological particles; a liquid distributor situated and configured to provide a substantially uniform flow in the liquid suspension of biological particles, wherein the substantially uniform flow is directed so that at least some of the biological particles accumulate in the acoustic wave at accumulation regions defined by the acoustic wave; and a drain configured to collect a portion of a liquid suspension having an enriched concentration of biological particles associated with the accumulated biological particles.

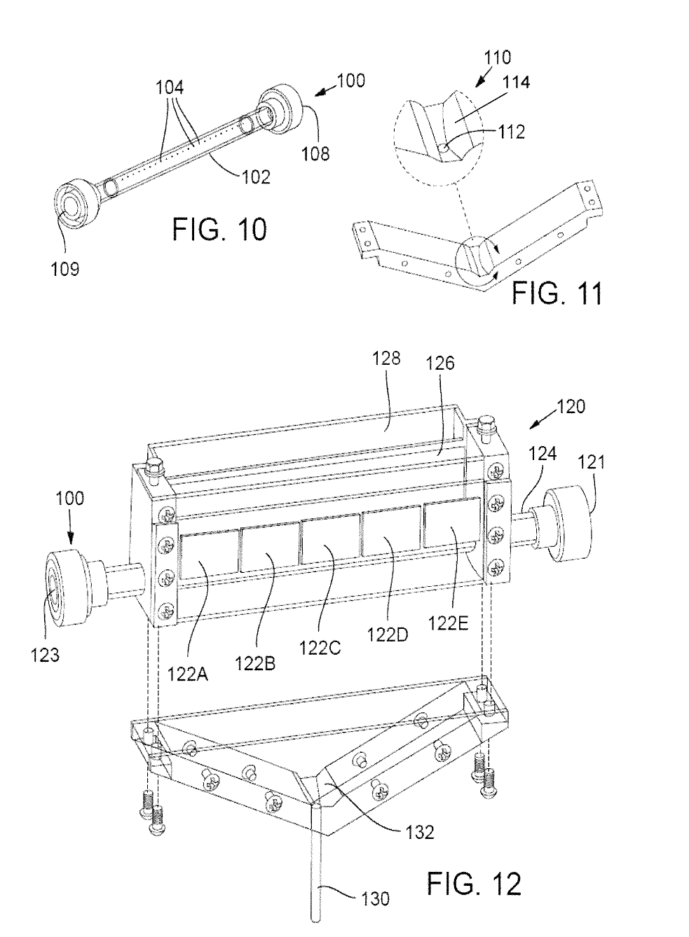

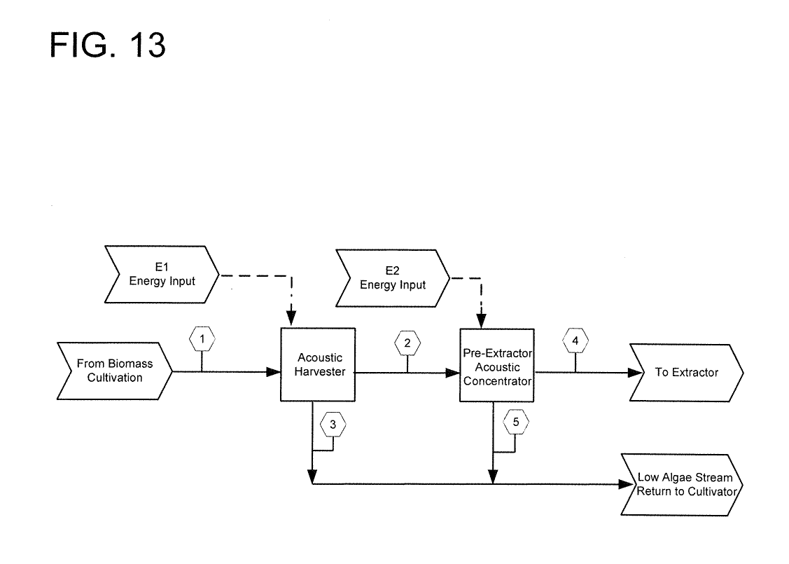

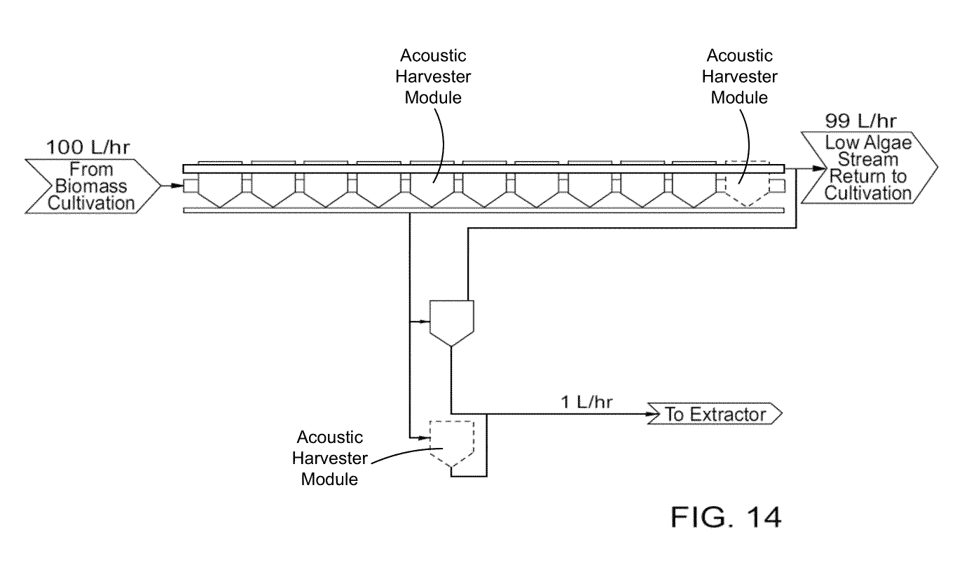

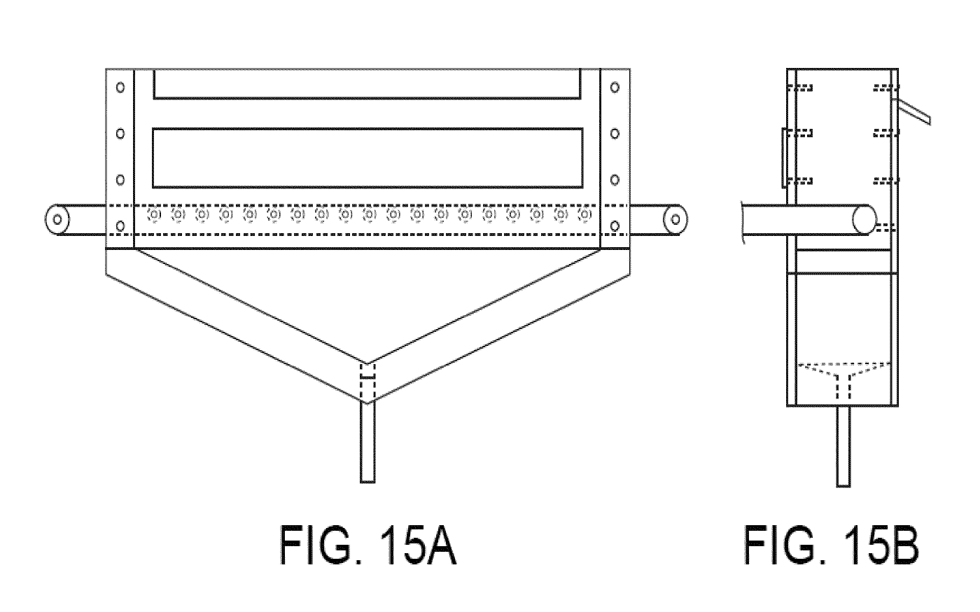

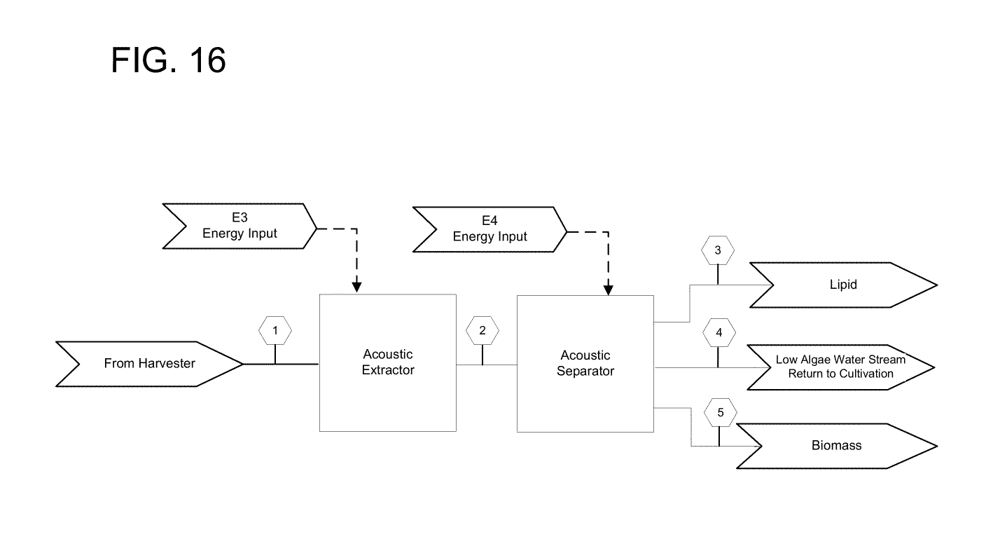

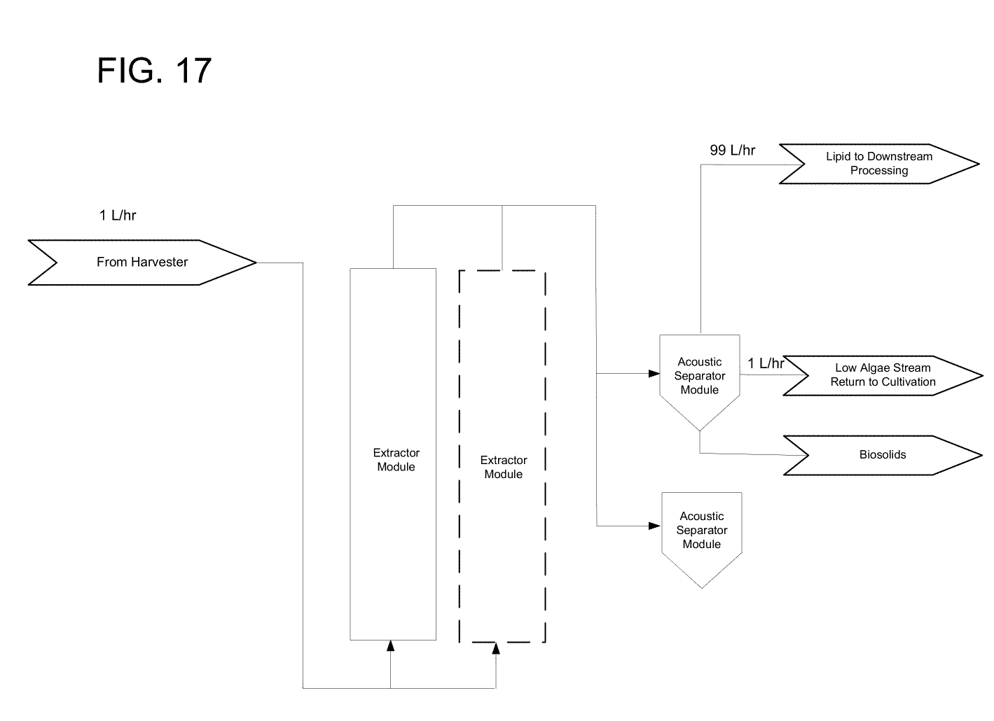

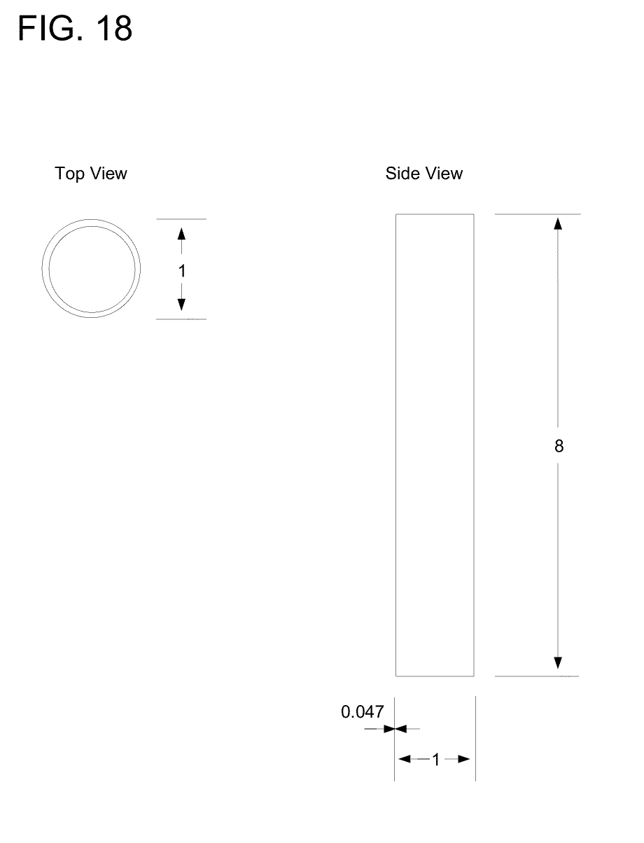

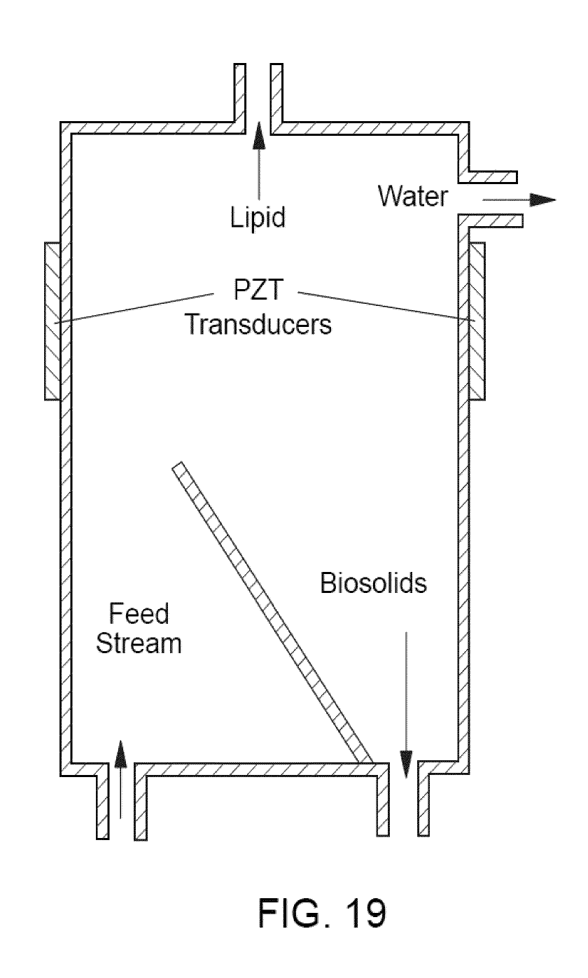

A representative liquid distributor 100 is illustrated in FIG. 10 and includes a tube 102 having holes 104 situated along the length of the tube. The liquid distributor 100 is designed to achieve a substantially uniform flow of the liquid suspension of biological particles. Typically, hole sizes such as hole diameters or areas are selected to promote uniform flow when a pressurized liquid is introduced into tube ends 108, 109. In the example of FIG. 10, the tube 102 has a constant circular cross-section, but rectangular, polygonal, elliptical, ovoid or other shapes and combinations of shapes can be used, and cross-sectional shape and size can vary to produce, for example, a tapered tube. The liquid distributor in FIG. 10 is exemplary only and is not intended to limit the apparatus to a particular mechanism for delivering the liquid suspension of biological particles to the acoustic field with a substantially uniform flow.

In some embodiments, the drain is situated vertically below accumulation regions defined by acoustic waves. In some examples, the drain comprises a tube having a drain pocket sloped to enhance flow-through of the enriched portion of the liquid suspension of biological particles. A representative drain pocket is illustrated in FIG. 11. The drain pocket 110 has an opening 112 with a slope 114 to enhance flow-through of a concentrated liquid suspension of biological particles. The apparatus can further include a chamber configured to receive the substantially uniform flow and situated with respect to the acoustic transducer so that the accumulation regions are defined in the chamber. In some examples, the apparatus further includes a spillway situated vertically above or below the accumulation regions. The spillway need not be situated directly above the accumulation regions but can be moved laterally away from the top of the accumulation regions. As used herein, the “vertically above” and vertically below” permit lateral offsets, and above and below refer to positions in which an extraction or separation apparatus is situated to be in use. The acoustic transducer can include a plurality of transducer sections, such as 2, 3, 4, 5, 6, 7, 8, 9, or 10 transducer sections. In particular examples, the acoustic transducer includes 5 transducer sections. An acoustic signal generator is typically coupled to the acoustic transducer and configured to establish accumulation regions based on an acoustic standing wave, an acoustic traveling wave, streaming or a combination thereof. In some examples, the acoustic signal generator and the acoustic transducer are configured to produce stationary accumulation regions. In other examples, the acoustic signal generator and the acoustic transducer are configured to produce non-stationary accumulation regions. Accumulation regions are generally located at or near acoustic wave nodes.

A representative apparatus for concentrating biological particles in a liquid suspension is depicted in FIG. 12. The acoustic concentrator 120 includes a plurality of acoustic transducer sections 122A-122E configured to produce an acoustic wave in a liquid suspension of biological particles, and a liquid distributor 124 configured to provide a substantially uniform flow in the liquid suspension of biological particles based on a liquid supplied at one or both distributor ends 121, 123. The substantially uniform flow is directed so that at least some of the biological particles accumulate in the acoustic wave at accumulation regions defined by the acoustic wave. The liquid distributor 124 extends through a chamber 126 configured to receive the substantially uniform flow and situated with respect to the acoustic transducer so that the accumulation regions are defined in the chamber. A spillway 128 is situated vertically above the accumulation regions. The acoustic concentrator 120 also includes a drain tube 130 situated vertically below the accumulation regions. The drain tube 130 is coupled to a drain pocket 132 sloped to enhance flow through of a concentrated liquid suspension of biological particles. As noted above, the drain tube 130 need not be directly below, but can be offset so long as accumulated, concentrated, or aggregated particles can be coupled to the drain tube 130.

B. Representative System for Extracting and Separating Target Material from a Liquid Suspension of Biological Particles

Extraction/separation systems include an acoustic concentrator configured to produce a biological particle enriched fluid based on an applied acoustic field. An acoustic extractor is coupled to receive the biological particle enriched fluid from the acoustic concentrator and extract a target material from the biological particles. An acoustic separator receives the enriched fluid and separates the extracted target material.

The acoustic concentrator can include an acoustic transducer configured to produce an acoustic wave in a liquid suspension of biological particles and a liquid distributor configured to provide a substantially uniform flow in the liquid suspension of biological particles. The substantially uniform flow is typically directed so that at least some of the biological particles accumulate in the acoustic wave at accumulation regions defined by the acoustic wave. A drain is configured to collect biological particles associated with the accumulation region. Typically, the drain is situated vertically higher or lower than the uniform flow so that biological particles move toward the drain based on gravitational forces. A representative acoustic concentrator is illustrated in FIG. 12.

An acoustic extractor can be situated to extract a target material from collected, accumulated particles. Such an extractor can comprise a chamber having one or more piezoelectric walls with electrodes on an inner surface and an outer surface. In some embodiments, such an extractor receives accumulated particles from an acoustic separator that includes an acoustic transducer configured to produce an acoustic wave within a chamber and establish accumulation regions; and a distributor situated within the chamber and configured to provide a substantially uniform flow of a liquid suspension containing the biological particles.

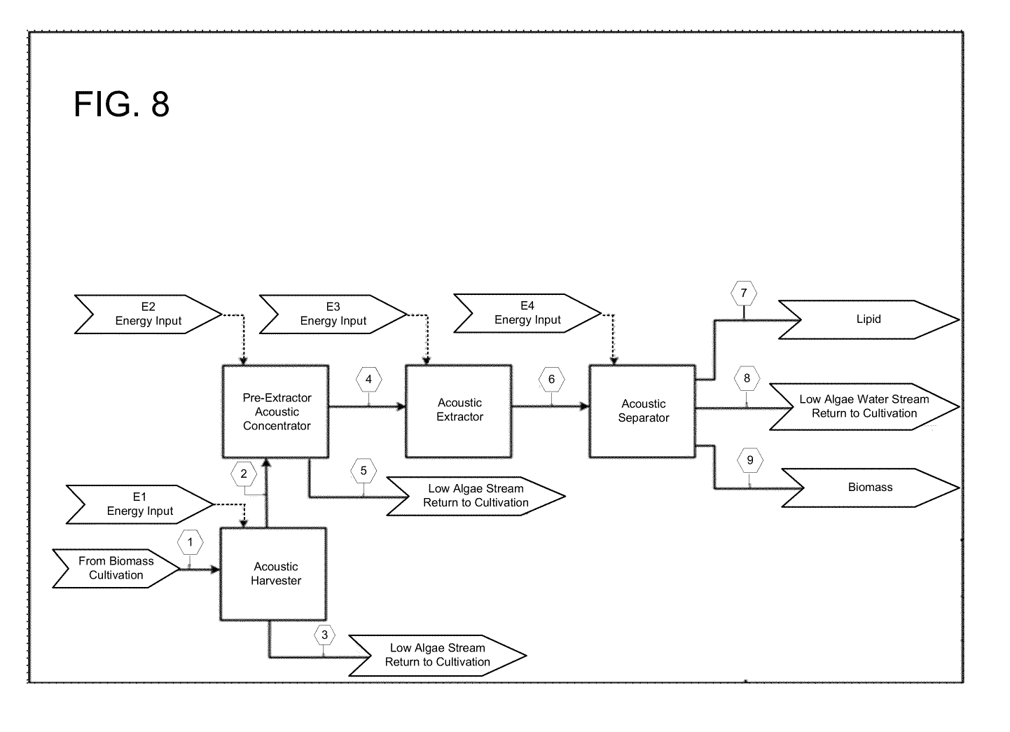

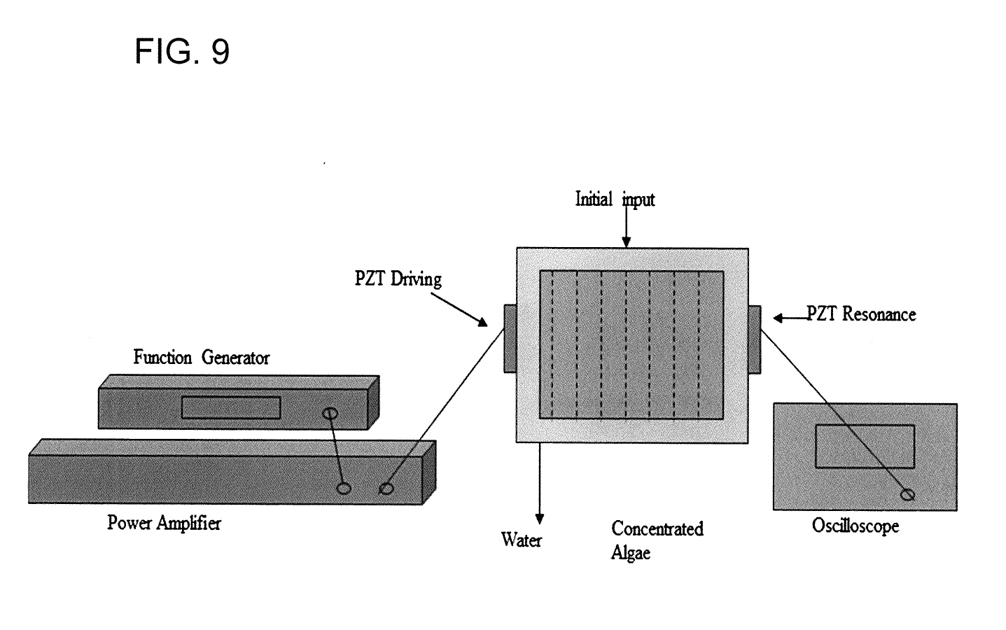

In some examples, the system is used to concentrate algae, and extract and separate lipids from the concentrated algae. A representative system for concentrating algae, and extracting and isolating lipids from the algae, is shown in FIG. 8. Algae cultures are harvested and concentrated by applying acoustic energy to an acoustic concentrator. An acoustic extractor receives the concentrated algae and disrupts the algae cell membranes by applying acoustic energy. The acoustic separator separates the extracted biological material, isolating lipids, water and other biomass (such as cellular debris, protein, nucleic acid etc.).

C. Method for Concentrating Biological Particles from a Liquid Suspension

Methods of concentrating biological particles from a liquid suspension include applying an acoustic field to the liquid suspension to concentrate the biological particles and separating the concentrated biological particles from the liquid suspension. In some examples, the acoustic field comprises a standing wave, a pulsed wave, a traveling wave, a radial acoustic field or a surface acoustic wave. In some examples, the biological particles include cells. Algae cells are exemplified herein, but the method is applicable to the separation other types of cells, such as blood cells (red blood cells, white blood cells, platelets etc.), bacterial cells, or yeast cells. In some embodiments, the biological particles may be attached to polystyrene or other beads to facilitate concentration by application of an acoustic field.

D. Method of Isolating Lipids from Algae Cultures

Methods of isolating lipids from algae include applying an acoustic field to a liquid suspension of algae to concentrate the algae; applying an acoustic field to the concentrated algae to extract lipids from the algae; and applying an acoustic field to separate the lipids from the algae. A representative method for isolating lipids from algae is depicted in FIG. 8. The acoustic field applied to the liquid suspension is selected so as to be suitable for concentrating the algae, such as a relatively high frequency acoustic wave. In some embodiments, the acoustic field applied to the concentrated algae is suitable to disrupt algae cell membranes, such as a relative low frequency acoustic wave. The algae can be any suitable species of algae for obtaining lipid, including prokaryotic or eukaryotic algae. In some embodiments, the algae are microalgae. The microalgae can be any type of microalgae, such as freshwater microalgae or marine microalgae. In some embodiments, the algae species is from the class or genus Nannochloropsis, Chlorella, Tetraselmis, Bacillariophyceae, Chlorophyceae, Cyanophyceae, Xanthophyceae, Chrysophyceae, Crypthecodinium, Schizocytrium, Ulkenia, Dunaliella, Cyclotella, Navicula, Nitzschia, Cyclotella, Phaeodactylum or Thraustochytrid, Botryococcus, Ankistrodesmus, Coelastrum, Scenedesmus, Klebsormidium, Dictyochloropsis, Kirchneriella, Phormidium, Lyngbya, Oocystis, Oscillatoria, Cosmarium, Leptolyngbya, Monoraphidium, Phormidium, Ulothrix, Anabaena, Uronema, Hydrodictyon, Chlorococum, Cladophora or Lemna. Rhodophyta (red algae), and Cyanobacteria (blue-green algae) are also encompassed by the present disclosure. In other embodiments, the algae are genetically altered, transgenic, environmentally adapted or synthetic algae.

In particular non-limiting embodiments, the algae are a species of Nannochloropsis, Chlorella or Tetraselmis. In one example, the algae are Nannochloropsis salina. In another specific example, the algae are Chlorella protothecoides. In yet another example, the algae are Tetraselmis striata.

In some embodiments, the method further includes at least one assay to monitor lipid content, cell quality or cell quantity of the algae. In some examples, the assay comprises a flow cytometry assay. In some cases, the flow cytometry assay measures lipid content of the algae using a fluorescent dye, such as BODIPY. The flow cytometry assay can also measure algae cell size, volume, granularity, chlorophyll content, DNA content, viability, or any combination thereof.

The following examples are provided to illustrate certain particular features and/or embodiments. These examples should not be construed to limit the disclosure to the particular features or embodiments described.

### EXAMPLES

### Example 1

### Ultrasonic Fields to Harvest and Extract lipids and Proteins from Algae

The present example uses ultrasonic fields to harvest and extract lipids and proteins from algae, and recover the water. The approach uses acoustic-focusing technology and minimal electrical energy to concentrate the algal cells and to fractionate the cells for separation into lipids and proteins. Ultrasonic resonators are used to concentrate and disrupt the algae, and separate the lipids from the rest of the biomaterials and the water. The lipids or oils can be refined into biofuel; the proteins used for animal feedstock; and the water recycled.

### Harvesting Algae, Extraction of Lipids and Biomaterials Separation

Acoustic harvester vessels were assembled from readily available materials and tested over a range of flow rates, excitation frequencies, and driving voltage to maximize available performance. Test-vessel volumes ranged from 4 ml to 300 ml. Cell disruption to release lipids was evaluated using a cylindrical extractor vessel and a hemisphere vessel. Cell lysis experiments were conducted in batch mode or flow-through mode, in volumes of 5-10 ml at 20-80 kHz and higher. For oil separation, emulsions prepared from canola oil and water, or algal oil and algal feedstock, were separated in 4 ml test vessels using parameters similar to those in the harvesting experiments. For the harvesting and cell lysis processes, the input power was measured directly during each process. The applied energy density was correlated to the effectiveness of the ultrasound treatment on the products of each process.

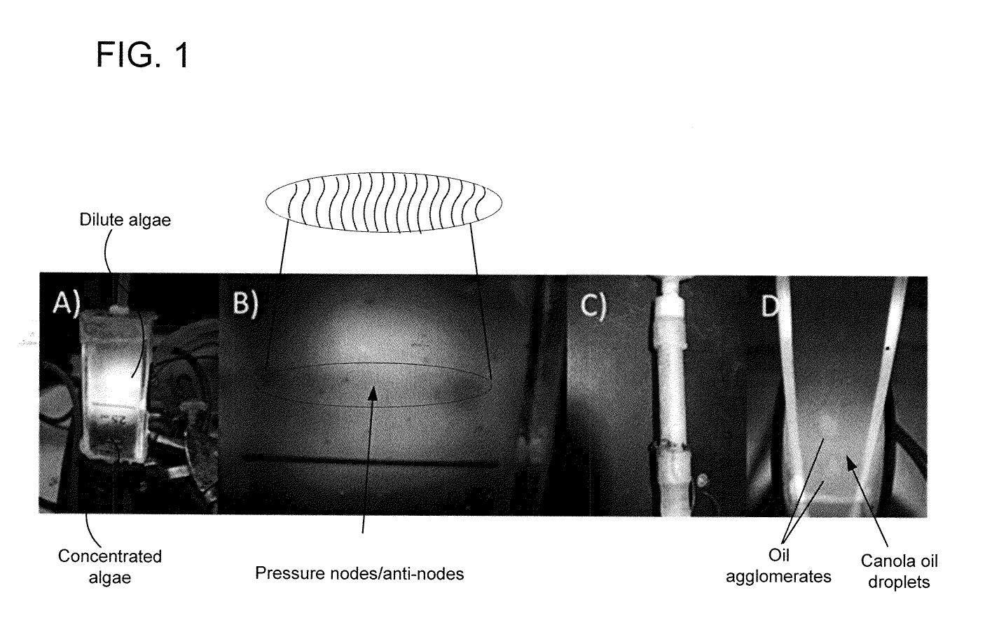

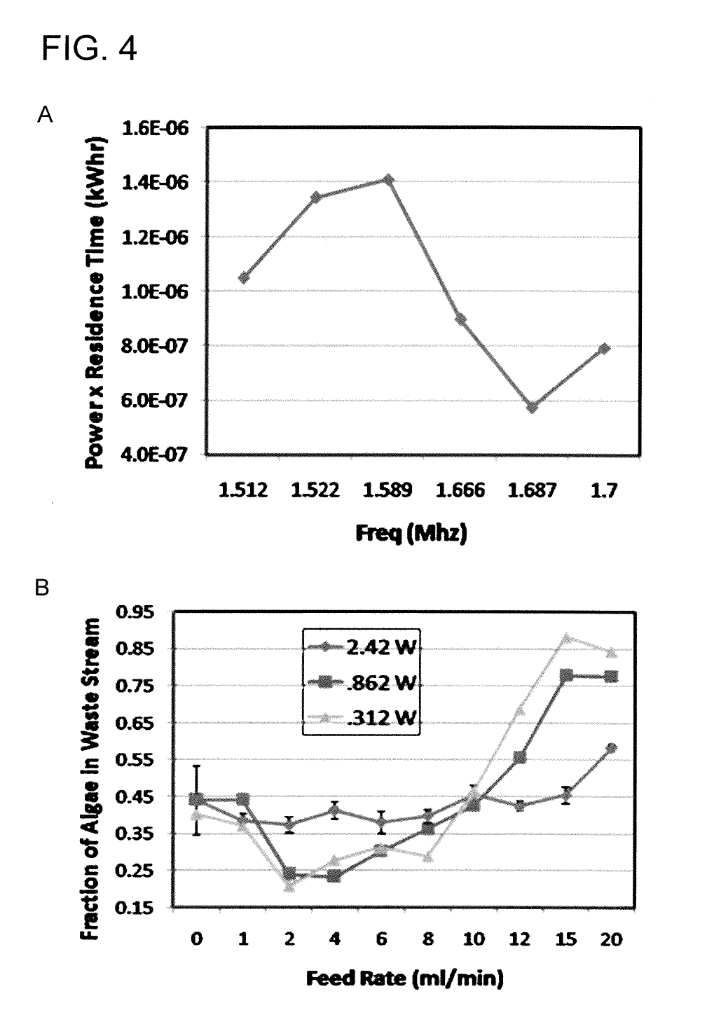

FIG. 1A shows a small flow-through harvester (120 ml). N. salina accumulate at the low pressure nodes (FIG. 1B). Optimum operating conditions are shown for frequency (FIG. 4A) and flowrate (FIG. 4B). FIG. 4A shows that for a fixed voltage, the energy consumed by the resonator is frequency-dependent, and optimum performance was pursued at minimum energy consumption. In FIG. 4B, for a fixed concentration, the concentrator performance is shown over a range of feed rates and power. In one example, the optimum flow rates were around 2, 4, and 15 ml/min going from lowest to highest power. Error bars on the high power data indicate +/−one standard deviation of three replicate tests. Typical results from experiments performed with constant voltage amplitude and constant frequency are shown. Other tests performed with feed streams of differing pH indicated that the pH for the acoustic harvester could be optimized to reduce energy consumption. For all experiments, the flow rate of the return stream was set at 90% of the feed stream flow rate, the flow rate of the product stream was set at 10% of the feed stream flow rate, and concentration increases of 10 to 20 fold were routine.

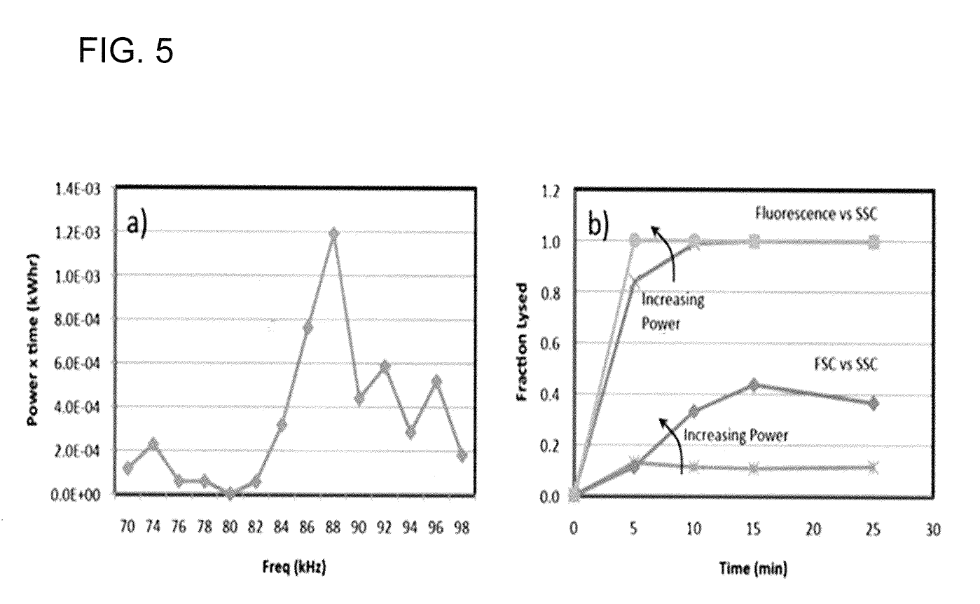

The cylindrical extractor vessel (FIG. 1C) was amenable to flow-through experiments. BODIPY stained lipid droplets appear as intracellular bright spots before operations and as extracellular droplets afterwards. Optimum operation was determined to be around 80 kHz (FIG. 5A) and residence times of 5 to 10 minutes are sufficient based on forward scattering and autofluorescence (FIG. 5B). FIG. 5A demonstrates that for a fixed voltage, the power consumed by the resonator is frequency dependent and optimum performance was pursued at minimum power consumption (i.e., circa 80 kHz). FIG. 5B demonstrates for a fixed concentration, the extractor performance is shown with increasing time. The optimum frequency is shown to be around 80 kHz where overall energy use is minimized. Significant changes occur within the first 5 minutes of powering the extractor and over slightly longer time periods for the lowest power investigated.

An emulsion prepared from canola oil and water was separated in the batch (4 ml) harvester vessel (FIG. 1D). The driving frequencies and power input were similar to those measured for harvesting and were shown to be effective at disrupting the emulsion. These results were incorporated into the process flow diagram.

The apparatus and methods disclosed herein can include batch or flow-through ultrasonic devices. In some cases, algae harvesting, bioproduct extraction, and separation are performed in discrete vessels designed specifically for the given unit process. The harvester vessel, used for algae concentration and dewatering, can be designed to generate an acoustic standing wave running perpendicular to the direction of media flow and force algae into low pressure nodes where they concentrate and settle. The acoustic energy density needed to achieve focusing, electrical power consumption and efficiency, and the range of flow rates whereby the harvester performs optimally is calculated depending on the particles. It is noted that the residence time in the batch extractor provides a rough estimate of the residence time needed in flow-through operations, being cognizant that the extractor is likely not operating at plug-flow conditions.

The propagation of sound waves and deposition of energy in the liquid layer of an acoustic vessel is a strong function of the materials used in the vessel design. Starting with the piezoelectric layer and working through the various vessel wall materials, their acoustic and thermomechanical properties and overall dimensions play a significant role in the fraction of energy available in the liquid layer for harvesting, extraction, or separation. In the present disclosure, the specific vessel design is optimized by considering the properties of available materials and determining the dimensions and driving frequency that maximizes the energy deposition in the liquid layer.

### Resonator Model

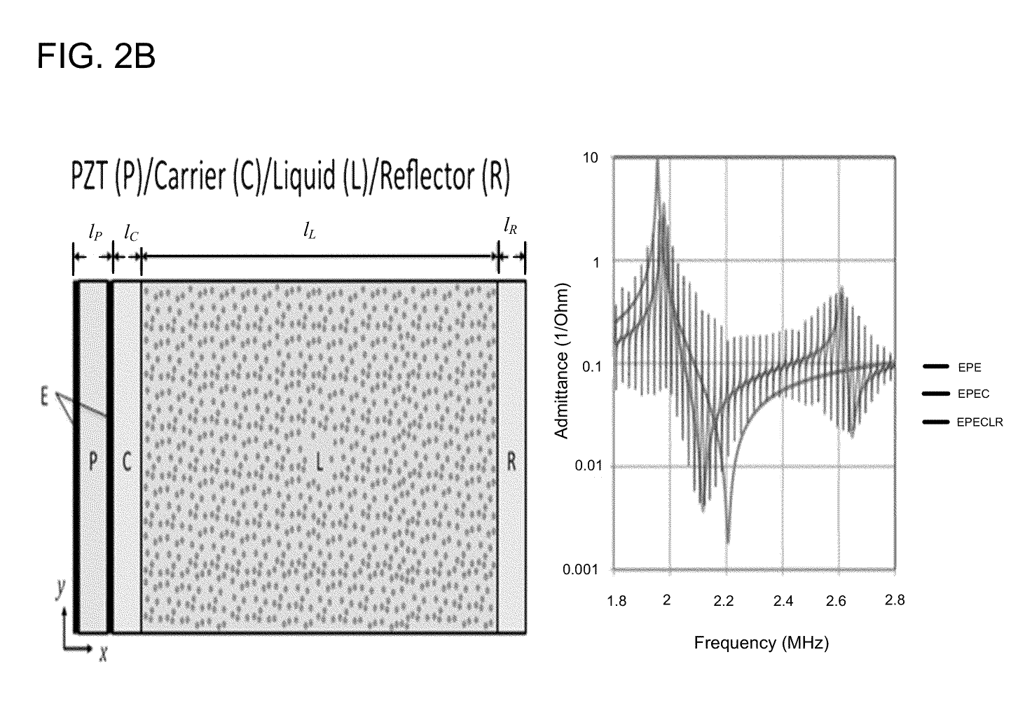

A layered resonator model is used for design, material property measurement, and to address the challenges of scale up. A four layered resonator system is shown in FIG. 2A, with algal water in the widest layer. The layered structure shows the arrangement and thickness of a 4 layered resonator vessel where the liquid (L) layer contains algae-like particles and the PZT (P) layer is attached to thin electrodes (E) on both sides. The electrodes and PZT layer form an acoustic transducer that is secured to a carrier plate (C) and the vessel is terminated by a reflector (R). FIG. 2B shows admittance spectra of a PZT resonator only, with the carrier layer, and with all four layers. The plot shows the predicted admittance-frequency spectra for a one (EPE), two (EPEC), and four (EPECLR) layered resonator vessel. Admittance spectra are measured independently using an impedance analyzer and layer properties can be determined by comparing measured spectra to model predictions. Multiple overtone resonance/anti-resonance frequencies are observed as a consequence of the thickness of a layer (e.g., the liquid layer) being large relative to the wavelength of the propagating sound wave.

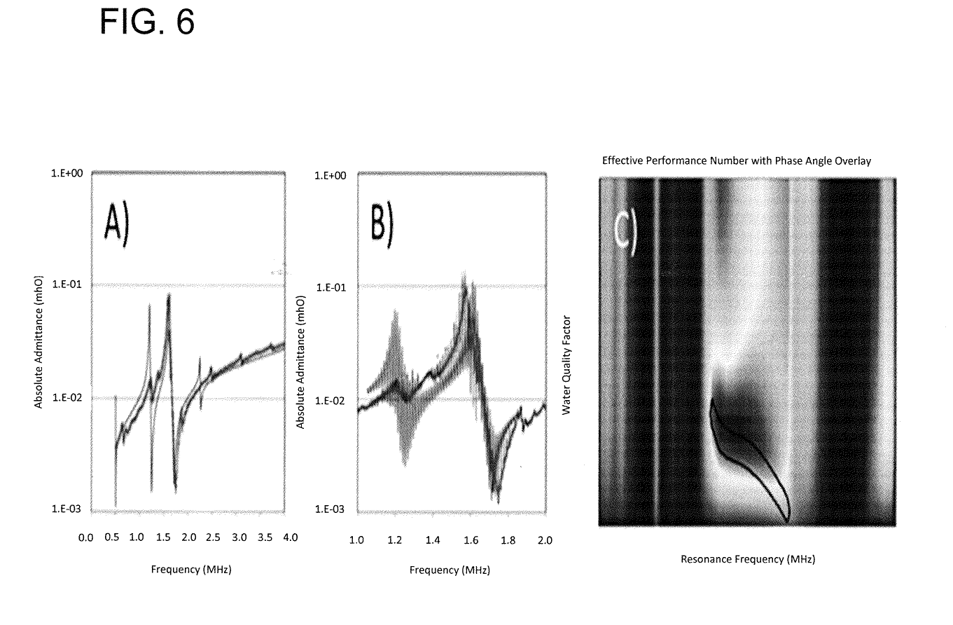

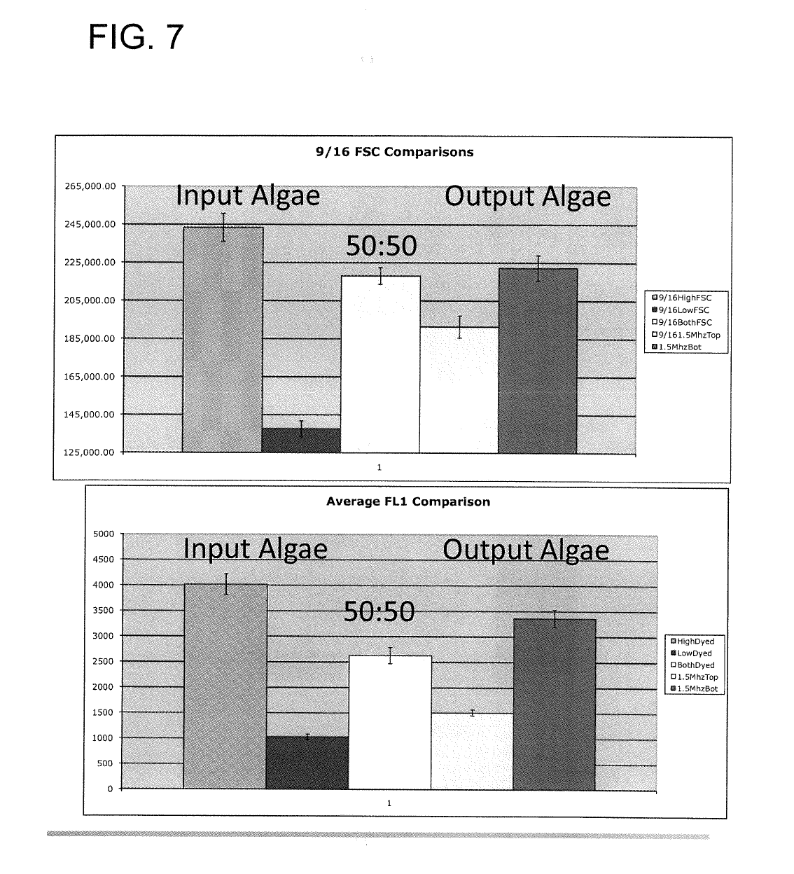

FIG. 6 shows the application of the layered resonator model for material property measurement and exploration of system control strategies. Admittance spectrum calculated by the model overlayed onto the measured spectrum of a 2-layer resonator (FIG. 6A) and a 4-layer resonator (FIG. 6B) is shown. FIG. 6C shows the overlay of the minimum phase angle with performance numbers over a broad operating range.

### Process Flow Diagram

Process flow diagram (PFD) based on laboratory-scale acoustic harvester and extractor experiments (FIG. 8). The energy input for each unit process is calculated in units of $US per gallon of lipid. Total costs range from $0.45 to $0.11 per gallon, depending on the assumptions made as follows:

### Case 1

Low efficiency resonator
Stream 1 contains 5 g of algae (dry mass) per kg of algal water
Stream 2 contains 50 g of algae (dry mass) per kg of algal water
Stream 3 contains 1 g of algae (dry mass) per kg of algal water
Algae is 50% lipid by mass
Algae diameter is approximately 2 microns
Density of the lipid is 0.87 g/cc
Harvester operates at 0.312 Watts and the cost of electrical energy is $0.08/kWhr
Harvester vessel is laboratory-scale and of arbitrary design. Approximately 15% of the electric energy is deposited in the liquid layer

### Case 2

High efficiency resonator
Same as Case 1, except the Harvester vessel design is optimized and its efficiency is 90%
Energy into the liquid layer is the same as in Case 1. Therefore, the product of the Harvester power and its efficiency is constant. This assumption reduces the required power for Case 2 by a factor of 6

### Case 3

Large algae cell size assumed
Same as Case 2, except that the algae diameter is approximately 3.6 microns. This is consistent with the diameter of high lipid N. salina measured by flow cytometry
Electric power is proportional to the mean radiation force needed to focus the algae
For a given electric power, the mean radiation force on the algae is proportional to the cube of the algae diameter. These assumptions reduce the required power by a factor of 0.83

### SUMMARY

The energy input for each unit acoustic process was calculated in $US per gallon of lipid. Total harvesting and extraction costs using ultrasound are estimated to be around 10¢ per gallon of oil for a feed stream containing 3 g of algae per liter of water. The PFD calculations confirmed the feasibility of scaling up the ultrasound approach to harvest and extract oil from algae. The effectiveness of the ultrasonic harvesting process has been demonstrated using multiple algae species, including Nannochloris sp., Nannochloropsis salina, Chlorella protothecoides, and Tetraselmis striata. Generally, the larger the individual algae cell, the more readily it can be harvested. Lipid-filled algae are also more easily harvested with acoustic fields than algae with low lipid content in the same sample.

### Discussion

Microalgae currently produce 15 to 300 times more biofuel than oil-seed crops per unit area of land (Schenk et al., Bioenerg Res 1:20-43, 2008). Despite this superior ability to convert atmospheric CO₂ to oil, it was recently estimated that technological hurdles associated with algae harvesting and oil extraction will delay any significant encroachment into the oil market until after 2050 (Lundquist et al., Report from the Energy Biosciences Institute, University of California, October 2010). Furthermore, without monumental transformation of current process technologies, the cost of algal biofuel is projected to be at least $150/bbl in 2010 dollars. Leading edge acoustic technology can profoundly transform these recent projections by cutting harvesting and extraction costs by as much as two orders of magnitude. This along with anticipated improvements in microalgae oil production could well take the US back to the future: carbon-neutral biocrude for $30/bbl.

Inefficient dissipation of acoustic energy through a water medium has helped to create a mindset that acoustic devices are only suitable for particle concentration over short (sub wavelength) spans and that inefficient energy-consuming acoustic doses are necessary for high-yield cell disruption. The size of currently available acoustic separation devices is orders of magnitude smaller than what is needed for high volume algal fuel production. Competing technologies traditionally more suited to large-scale operations are currently too costly to produce a viable and sustainable alternative to crude oil. This technology is scalable to commercial scale and less expensive to operate than traditional methods. Additionally, the ultrasonic harvesting and extraction method is environmentally friendly. Starting with a pond feedstock, the harvester uses no additives to separate the media into three product steams consisting of extracted lipids, biosolids and clean reusable water. Recent experimental results indicate that acoustic harvesters can significantly reduce harvesting costs and that the technology can be scaled-up within the constraints of the underlying physics to produce an industrial scale acoustic harvester that will be portable be deployed on site. With appropriate investment, acoustic technology will provide the low cost alternative needed to shift the US away from costly and environmentally unfriendly crude oil to a new era of low-cost carbon-neutral biofuel.

### Example 2

### Fast-Acting Intracellular BODIPY Lipid Assay

This example describes the development of a BODIPY-based lipid assay that reduces the turn-around time for lipid content measurement from several days with conventional solvent extraction and analysis to a few minutes and requires only a few microliters of algal pond water.

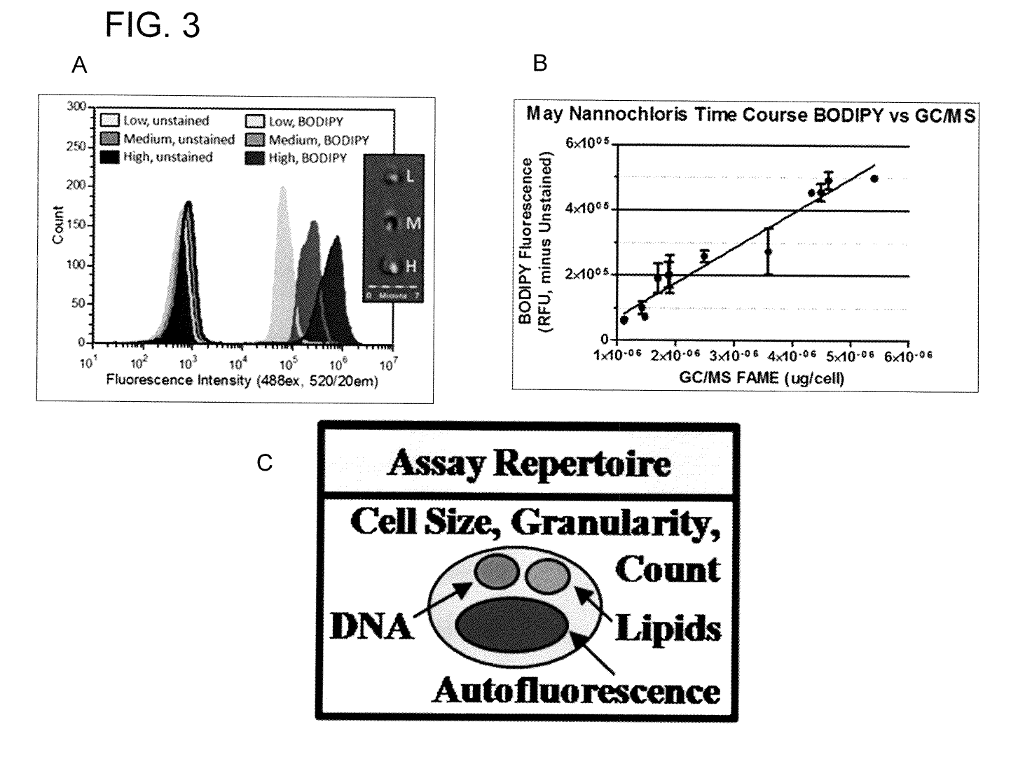

FIG. 3A is a histogram showing BODIPY fluorescence in three different Nannochloris sp. samples with varying levels of fatty acid methyl esters (FAMEs). Unstained samples show very little fluorescence, while stained samples show a delineation from low to high lipid content. Inset of fluorescence images shows larger and brighter lipid bodies in algal cells containing the high (H) levels of FAMEs. FIG. 3B shows a comparison of lipid quantification methods for a culture of Nannochloris sp. The BODIPY fluorescence correlates well with the FAME values (in μg/cell) acquired by GC-MS. FIG. 3C shows assays used to analyze algal samples, including cell size (forward scatter), cell granularity (side scatter), cell count, DNA content, lipid content and autofluorescence. These results demonstrate that the flow cytometry assay disclosed herein provides a rapid assay to monitor lipid content in algae, such as in N. salina, with BODIPY 505/515.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. An apparatus, comprising:
an acoustic transducer configured to produce an acoustic wave in a liquid suspension of biological particles;
a liquid distributor situated and configured to provide a substantially uniform flow in the liquid suspension of biological particles that extends along at least an axis of the liquid distributor, wherein the substantially uniform flow is directed so that at least some of the biological particles accumulate at accumulation regions defined by the acoustic wave; and
a drain configured to collect a portion of a liquid suspension having an enriched concentration of biological particles associated with the accumulated biological particles.

2. The apparatus of claim 1, wherein the liquid distributor comprises a tube having holes situated along a tube length.

3. The apparatus of claim 1, wherein the drain is situated vertically below the accumulation regions.

4. The apparatus of claim 1, wherein the drain comprises a tube having a drain pocket sloped to enhance flow through of the enriched portion of the liquid suspension of biological particles.

5. The apparatus of claim 1, further comprising a chamber configured to receive the substantially uniform flow and situated with respect to the acoustic transducer so that the accumulation regions are defined in the chamber.

6. The apparatus of claim 5, further comprising a spillway situated vertically above the accumulation regions.

7. The apparatus of claim 1, wherein the acoustic wave propagates in a direction that is perpendicular or parallel to a flow direction of the uniform flow.

8. The apparatus of claim 1, further comprising an acoustic signal generator coupled to the acoustic transducer and configured to establish accumulation regions based on an acoustic standing wave, an acoustic traveling wave, streaming, or a combination thereof.

9. The apparatus of claim 8, wherein the acoustic signal generator and the acoustic transducer are configured to produce stationary accumulation regions.

10. The apparatus of claim 8, wherein the acoustic signal generator and the acoustic transducer are configured to produce non-stationary accumulation regions.

11. A system comprising:
an acoustic concentrator configured to produce a biological particle enriched fluid based on an applied acoustic field;
an acoustic extractor coupled to receive the biological particle enriched fluid from the acoustic concentrator and extract a target material from the biological particles; and
an acoustic separator configured to separate the extracted target material from the biological particle enriched fluid.

12. The system of claim 11, wherein the acoustic extractor comprises a chamber defined by at least one piezoelectric wall having electrodes on an inner wall surface and an outer wall surface.

13. The system of claim 11, wherein the acoustic separator comprises:
an acoustic transducer configured to produce an acoustic wave within a chamber and establish accumulation regions; and
a distributor situated within the chamber and configured to provide a substantially uniform flow of a liquid suspension containing the biological particles into the accumulation regions.

14. A method of concentrating biological particles from a liquid suspension, comprising:
establishing a substantially uniform flow of the liquid suspension extending along at least one axis;
applying an acoustic field to the uniform flow of the liquid suspension to concentrate the biological particles at accumulation regions; and
separating the concentrated biological particles from the liquid suspension.

15. The method of claim 14, wherein the acoustic field comprises a standing wave, a pulsed standing wave, a traveling wave, a radial acoustic field or a surface acoustic wave.

16. The method of claim 14, wherein the biological particles comprise cells.

17. The method of claim 16, wherein the cells are algae cells.

18. A method of isolating lipids from algae, comprising:
applying a first acoustic field to a liquid suspension of algae to concentrate the algae;
applying a second acoustic field to the concentrated algae to extract lipids from the algae; and
applying a third acoustic field to separate the lipids from the algae.

19. The method of claim 18, wherein the first acoustic field is configured to concentrate the algae at accumulation regions defined by the acoustic wave.

20. The method of claim 18, wherein the second acoustic field is configured to separate the lipids by disrupting algae cell membranes.

21. The method of claim 18, wherein the algae are microalgae.

22. The method of claim 21, wherein the microalgae are freshwater microalgae.

23. The method of claim 21, wherein the microalgae are marine microalgae.

24. The method of claim 18, wherein the algae are a species of Nannochloropsis, Chlorella, Tetraselmis, Bacillariophyceae, Chlorophyceae, Cyanophyceae, Xanthophyceae, Chrysophyceae, Crypthecodinium, Schizocytrium, Ulkenia, Dunaliella, Cyclotella, Navicula, Nitzschia, Cyclotella, Phaeodactylum or Thraustochytrid, Botryococcus, Ankistrodesmus, Coelastrum, Scenedesmus, Klebsormidium, Dictyochloropsis, Kirchneriella, Phormidium, Lyngbya, Oocystis, Oscillatoria, Cosmarium, Leptolyngbya, Monoraphidium, Phormidium, Ulothrix, Anabaena, Uronema, Hydrodictyon, Chlorococum, Cladophora or Lemna.

25. The method of claim 18, wherein the algae are genetically altered, transgenic, environmentally adapted or synthetic algae.

26. The method of claim 18, further comprising at least one assay to monitor lipid content, cell quality or cell quality of the algae, or any combination thereof.

27. The method of claim 27, wherein the assay comprises a flow cytometry assay.

28. The method of claim 28, wherein the flow cytometry assay measures lipid content of the algae using a fluorescent dye.

29. The method of claim 27, wherein the flow cytometry assay measures algae cell size, volume, granularity, chlorophyll content, DNA content, viability, or any combination thereof.
